(19) United States
(12) Patent Application Publication
(10) Pub. No.: US 2002/0172121 A1
(43) Pub. Date: Nov. 21, 2002

(54) Method for recording information on optical recording medium and optical recording medium on which information is recorded

(75) Inventors: Takeo Ohta, Nara (JP); Kenichi Nishiuchi, Osaka (JP)

Correspondence Address: MERCHANT & GOULD PC, P.O. BOX 2903, MINNEAPOLIS, MN, 55402-0903, US

(73) Assignee: Matsushita Electric Industrial Co., Ltd., Kadoma-shi (JP)

(21) Appl. No.: 10/123,893

(22) Filed: Apr. 16, 2002

(30) Foreign Application Priority Data
Apr. 19, 2001 (JP) 2001-120480

(51) Int. Cl. G11B 7/0045

(52) U.S. Cl. 369/59.11

(57) ABSTRACT

An information recording device that records information on an optical recording medium includes: a laser beam generation device for generating a pulse light with a pulse width less than 1 ns; and a mark formation device for collecting the pulse light and irradiating a recording layer in the optical recording medium with the pulse light so as to form a mark in the recording layer, whereby generation of re-crystallization regions and a variation in the position of marks can be controlled appropriately and information can be recorded on an optical recording medium at high density.

### BACKGROUND OF THE INVENTION

1. Field of the Invention

The present invention relates to an information recording device and an information recording method capable of recording, erasing, and adding information at high density with respect to an optical recording medium. The present invention also relates to an optical recording medium on which information is recorded.

2. Related Background Art

As optical recording media utilizing the thermal energy of light, phase-change recording media, recordable dye media, magnetic-optical recording media, and the like are well known. Since these optical recording media have the advantage that mass information can be recorded on a compact and lightweight medium, they are used for a video disk, an audio disk, a still picture file, a disk memory for computer, and the like.

Further, with the advent of the IT era, demands for high-density recordable optical recording media are increasing recently so as to record a large amount of mass information such as color still pictures.

Under such circumstances, various proposals have been made concerning technologies for high-density recording onto an optical recording medium. For example, these technologies include a technology of increasing the resolution of an optical recording medium itself by improving a material used for the optical recording medium and a technology of increasing the resolution of an optical recording medium by making a recorded mark (hereafter simply referred to as “mark”) minute so as to increase a density of the marks formed on the optical recording medium.

For the phase-change recording media and the recordable dye media, attempts have been made to make their marks minute by decreasing the spot size of a laser beam. Since the spot size is proportional to a wavelength of the laser beam and inversely proportional to a numerical aperture of an objective lens, the following technologies have been proposed. That is,

1) a technology of shortening a wavelength of light emitted from a laser source by using a blue laser or the like, and

2) a technology of increasing a numerical aperture of an objective lens.

For the magnetic-optical recording media, a technology has been proposed to make a magnetic field generating element included in a recording head minute so that a gap between the recording head and the magnetic-optical recording medium can be narrowed.

However, these described technologies, which simply reduce the spot size of the laser beam or the like, have a limitation in recording information on an optical recording medium at high density.

The following describes problems in the prior art more specifically, with reference to a drawing.

FIGS. 5A and 5B schematically show a state where a mark is formed in a phase-change recording medium 20 according to a prior art. Here, numeral 21 indicates a substrate made of polycarbonate, 22 indicates a first dielectric layer made of ZnS—SiO₂ (Elm thickness: 160 nanometers (nm)), 23 indicates a recording layer made of TeGeSb (film thickness: 25 nm), 24 indicates a second dielectric layer made of ZnS—SiO₂ (film thickness: 25 nm), 25 indicates a reflective layer made of an aluminum alloy (film thickness: 110 nm), and 26 indicates a protective board made of polycarbonate, respectively.

A laser beam 31 emitted from a laser source (not illustrated) is collected with an objective lens 32 and the recording layer 23 in the phase-change recording medium 20 is irradiated with the laser beam. As a result, a light irradiated portion 35 is heated by the thermal energy of the laser beam 31, SO that a temperature of the portion increases to several hundreds degrees and the phase of the portion changes from a crystal phase to an amorphous phase, whereby a mark is formed. In this step, an optical density difference (hereafter called “contrast”) is generated between the mark and other portions. This contrast becomes an important factor for improving a S/N ratio characteristic (or noise versus signal characteristic) of a reproduction signal from the phase-change recording medium 20. In the prior art, in order to enhance the contrast, the energy and the pulse width of the laser beam when recording information on the phase-change recording medium 20 are set at approximately 1 nano-joule/μm² (nJ/μm²) and in a range of 30 to 100 nanoseconds (ns), respectively.

In addition, in order to increase a density of marks formed, it also is important to narrow a space between marks (i.e., a pitch and a track width of the marks). In this respect, an optical density gradient between a mark portion and its peripheral portion needs to be increased.

However, when observing the mark at the light irradiated portion 35 formed according to the above-stated prior arts with a transmission electron microscope (TEM), re-crystallization regions were found on the periphery of an amorphous region 36, where crystals different in grain size were present.

Then, when investigating the re-crystallization regions in detail, the following facts were found:

1) the re-crystallization regions are unstable in optical density, where marks cannot be formed clearly (hereafter called “dead space 37”), and

2) a size of the re-crystallization region becomes larger in proportion to a light irradiation time, irrespective of a spot size of a beam.

More specifically, with an irradiation of the laser beam 31 with a spot size of 1 μm in diameter for a duration in a range of 30 to 100 ns, the dead spaces 37 of approximately 40 to 200 nm in width were formed on the periphery of the amorphous region 36. Since the width of the dead space 37 became larger in proportion to the irradiation time, it can be assumed that heat diffusion resulting from the heat generated at the light irradiated portion 35 contributes much to the formation of the dead space 37.

In the prior art, a space between the marks has to be widened so as to keep away from the dead space 37, which hinders realization of high-density recording onto an optical recording medium. Also, the position of the mark varies under the influence of the heat diffusion, which may cause jitter. Further, when widening the space between marks so as to provide a region where no information is recorded between the marks, the overall size of the phase-change recording medium has to be increased.

Also in the recordable dye media and the magnetic-optical recording media, thermal energy of light is utilized for forming marks like in the phase-change recording media. Thus, a dead space whose width is proportional to an irradiation time is formed on the periphery of a mark, irrespective of a spot size of the laser beam and a size of the magnetic field generating element included in the recording head.

### SUMMARY OF THE INVENTION

Therefore, with the foregoing in mind, it is an object of the present invention to provide an information recording device and an information recording method capable of recording information on an optical recording medium at high density and to provide an optical recording medium on which information can be recorded with such a method.

To achieve the above-stated object, an information recording device of the present invention includes: a laser beam generation device for generating a pulse light with a pulse width less than 1 ns; and a mark formation device for collecting the pulse light and irradiating a recording layer in the optical recording medium with the pulse light so as to form a mark in the recording layer.

In addition, to achieve the above-stated object, an information recording method of the present invention includes: generating a pulse light with a pulse width less than 1 ns; collecting the pulse light; and irradiating a recording layer in the optical recording medium with the pulse light so as to form a mark in the recording layer.

These constructions can provide an information recording device and an information recording method by which generation of re-crystallization regions and a variation in the position of a mark can be controlled appropriately and information can be recorded on an optical recording medium at high density.

Furthermore, to achieve the above-stated object, an optical recording medium of the present invention includes a recording layer in which a mark is formed by an irradiation of a pulse light with a pulse width less than 1 ns.

With this construction, a space between the marks can be narrowed, and therefore a compact and lightweight optical recording medium, on which a large amount of mass information such as a color still picture can be recorded, can be provided.

### BRIEF DESCRIPTION OF THE DRAWINGS

FIG. 1 is a schematic diagram showing an example of an information recording device according to the present invention;

FIG. 2 is a cross-sectional view showing an example of a phase-change recording medium that is applicable to the present invention;

FIG. 3 is a graph showing a relationship between the pulse width and the width of re-crystallization region;

FIGS. 4(a) and 4(b) are microphotographs taken by TEM, showing the state of marks formed on a phase-change recording medium (FIG. 4(a): pulse width (60 ns) and FIG. 4(b): pulse width (120 fs)); and

FIGS. 5A and 5B are a schematic diagram showing a method of recording information on a phase-change recording medium according to a prior art.

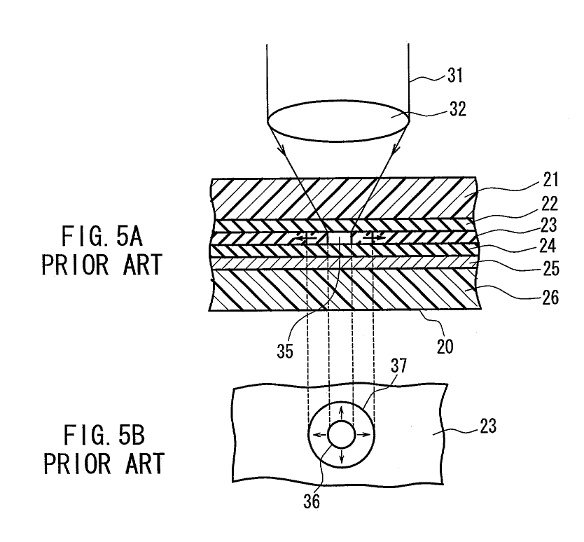

### DETAILED DESCRIPTION OF THE INVENTION

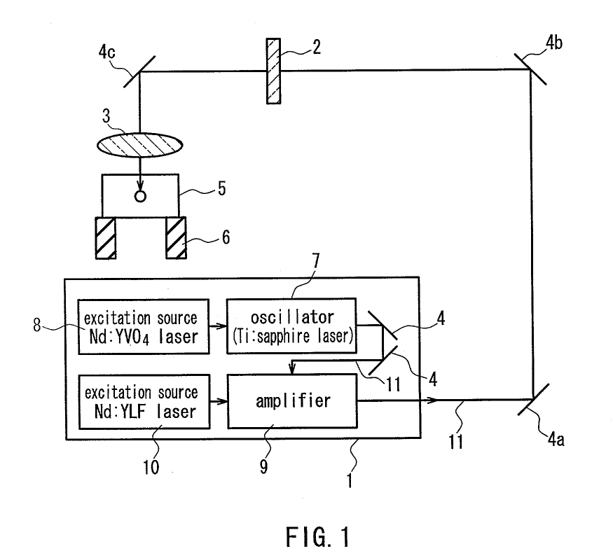

The following describes embodiments of the present invention, with reference to the drawings. FIG. 1 schematically shows an information recording device according to one embodiment of the present invention and a state where a mark is formed in a phase-change recording medium using the device.

In this figure, numeral 1 indicates a laser beam generation device that generates a pulse laser beam (wavelength: 700 to 900 nm) with a pulse width less than 1 ns. Numeral 2 indicates a density filter that adjusts a light intensity of the laser beam. Numeral 3 indicates an objective lens that collects laser beams, 4 indicates a reflective mirror, 5 indicates an optical recording medium, and 6 indicates a driving unit that moves a light irradiated portion in the optical recording medium 5, respectively.

In the laser beam generation device 1, numeral 7 indicates an oscillator (titanium:sapphire laser), 8 indicates an Nd:YVO₄ laser excitation source that excites the oscillator 7, 9 indicates an amplifier that amplifies a laser output from the oscillator 7, and 10 indicates an Nd:YLF laser excitation source that excites the amplifier 9. Note here that a laser driving signal generation device (not illustrated) that allows a laser light to be emitted in response to an information signal is connected to the laser beam generation device 1.

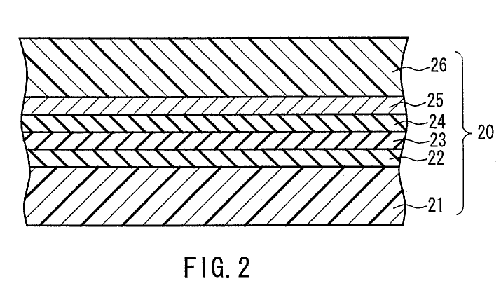

FIG. 2 is a schematic diagram showing a construction of an example of the phase-change recording medium 20. Numeral 21 indicates a substrate made of polycarbonate, 22 indicates the first dielectric layer made of ZnS—SiO₂ (film thickness: 160 nm), 23 indicates a recording layer made of TeGeSb (film thickness: 25 nm), 24 indicates the second dielectric layer made of ZnS—SiO₂ (film thickness: 25 nm), 25 indicates a reflective layer made of an aluminum alloy (film thickness: 110 nm), and 26 indicates a protective board made of polycarbonate, respectively. Here, the reflective layer 25 can be omitted.

The following describes a method for recording information on the phase-change recording medium 20 by forming a mark therein using the information recording device according to the embodiment as stated above, and an experimental result according to the method, with reference to the drawings.

In the laser beam generation device 1, a laser beam is generated by the Nd:YVO₄ laser excitation source 8, a pulse width of the beam is modulated to be less than 1 ns by the oscillator 7 so as to be a pulse laser beam 11, and the laser output thereof is amplified by the amplifier 9 to be emitted toward the outside. Next, the emitted pulse laser beam 11 is reflected from reflecting mirrors 4a and 4b so that the direction is converted, the light intensity of the beam is adjusted by the density filter 2, and the beam is reflected from a reflective mirror 4c so that the direction is converted again. Then, the beam is collected by the objective lens 3 and focused on the recording layer in the phase-change recording medium 5 where a mark is to be formed.

The experiment was conducted to form marks under the following conditions. That is, a wavelength of a laser beam, an irradiation energy of the laser beam, a numerical aperture of the objective lens, and a linear speed of the phase-change recording medium 20 were set at 800 nm, 2 nJ/μm², 0.95, and 10 m/s, respectively. Then, marks were formed in the recording layer of the phase-change recording medium 20, while changing the pulse width of the laser beam in a range of 100 femto-seconds (fs) to 1 ns. As a result of an observation with TEM, marks where the phase of the TeGeSb changed from the crystal phase into the amorphous phase were formed at portions subjected to an irradiation of the laser beams. Also, a tendency toward smaller width of the re-crystallization region was confirmed as the pulse width was decreased while the laser output i.e., a peak value of the pulse) was amplified.

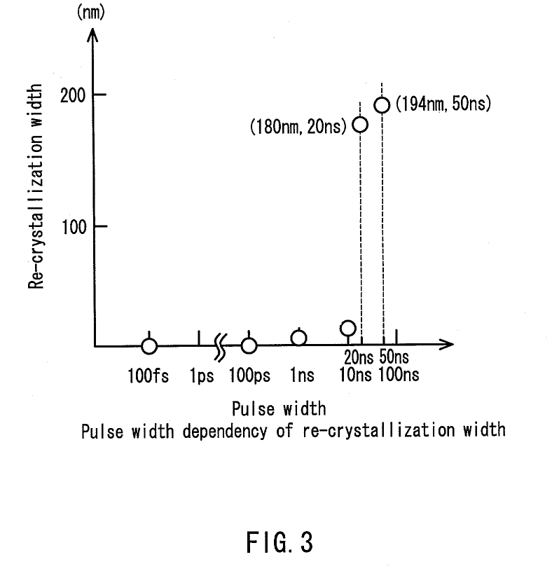

FIG. 3 is a graph showing a result of this experiment. As indicated in this graph, when irradiating with laser beams having the pulse widths of 50 ns and 20 ns, re-crystallization regions of 194 nm and 180 nm in width were formed on the periphery of the mark, respectively. In the case of the pulse width of 10 ns, a re-crystallization region of approximately 10 nm in width was formed. Further, in the case of the pulse width of 1 ns, the width of a formed re-crystallization region was approximately 2 to 3 nm, and in the case of the pulse width less than 10 pico-seconds (ps), a re-crystallization region was hardly formed. When comparing between the states of re-crystallization regions generated in the cases of pulse widths of 10 ps and 100 fs, hardly any difference was found. Moreover, when the pulse width was set less than 10 ps, hardly any variation in the position of the mark due to heat diffusion also was found.

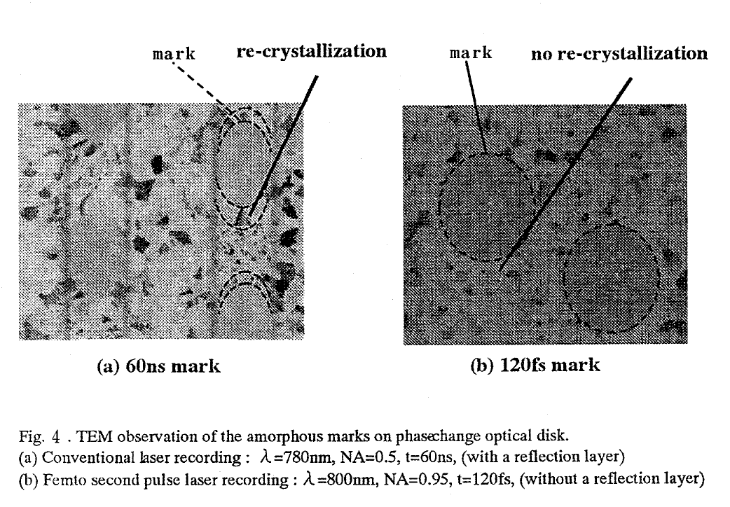

FIG. 4(a) is a microphotograph taken by TEM, showing the state of the re-crystallization regions generated on the periphery of the marks in the case of the pulse width of 60 ns.

Meanwhile, when forming marks using a phase-change recording medium without the reflective layer 25 in the same conditions as in the above experiment, in the case of the pulse width of 10 ps or less, hardly any generation of re-crystallization regions or variation in the position of the mark was observed. As indicated in FIG. 4(b), in the case of the pulse width of 120 fs, there are no re-crystallization regions on the periphery of the marks.

From the above-stated experimental result in the present invention, the pulse light with a pulse width less than 1 ns needs to be used when forming a mark in the recording layer of the phase-change recording medium. Thereby, generation of re-crystallization regions and a variation in the position of the mark can be controlled effectively.

Note here that, in this embodiment, if information is re-recorded on the phase-change recording medium on which information has been recorded, the second laser beam generation device may be used in addition to the above laser beam generation device 1. The second laser beam may be adapted to emit a laser beam to be interlocked with the laser beam emitted from the laser beam generation device 1, and a laser output from the second laser beam generation device may be set at a level so that the information recorded on the phase-change recording medium can be erased. In this state, while irradiating with a laser beam emitted from the second laser beam generation device, a mark can be formed with a pulse laser beam 11 emitted from the laser beam generation device 1. Alternatively, if the second laser beam generation device is arranged with respect to the moving direction of the phase-change recording medium so that the phase-change recording medium can be irradiated with the laser beam emitted from the second laser beam generation device prior to that from the laser beam generation device 1, then the mark corresponding to the recorded information can be erased immediately followed by recording new information onto the portion subject to the erasing with the pulse laser beam 11 emitted from the laser beam generation device 1. Thereby, a so-called overwrite can be performed onto the phase-change recording medium. With these methods, the following effects can be obtained:

1) the choice for lasers can be broadened, and therefore a cheap laser source can be used,

2) compatibility with an information recording device used previously can be established, and

3) the life of a phase-change recording medium can be increased.

Furthermore, in this embodiment, the third laser beam generation device generating a laser beam with a pulse width of 1 ns or more may be used, where the laser beam emitted from the third laser beam generation device is superimposed on a laser beam emitted from the laser beam generation device 1, so that a laser output from the laser beam generation device 1 can be lowered.

Although the above description deals with an example where the phase-change recording medium is used as an optical recording medium, this embodiment also is applicable to recordable dye media and magnetic-optical recording media in which marks can be formed using the thermal energy followed by heat diffusion.

In the present invention, insofar as a pulse light with a pulse width less than 1 ns is emitted, any laser beam generation device can be used. For example, the laser beam generation device as described in the above embodiment is used preferably, because it allows a minute and high-resolution mark to be formed at high speed and the width of the re-crystallization region can be controlled to be 10 nm or less.

Also, preferably, the pulse width is set 10 ps or less. Thereby, the width of the re-crystallization region can be made considerably small, and hardly any variation in the position of the mark is found, so that a mark can be formed at higher-resolution and at higher speed.

Note here that, when using a laser beam, it is preferable that a wavelength, light intensity, and pulse width of the laser beam is optimized appropriately in accordance with the characteristics of the optical recording medium used and the intended purpose of use.

In addition, in the present invention, it is preferable that the optical recording medium used is capable of recording information converted into an optical signal thereon, forming a mark corresponding to the information therein by changing the optical characteristics such as an optical density thereof, and reading the information therefrom by detecting the formed mark with an optical means.

Therefore, recordable dye media, polymer recording media, or the like can be used as the optical recording media for the present invention, as alternatives for the phase-change recording medium used in the above embodiment, which utilizes a metal, semimetal, dye, polymer, etc. whose optical characteristics change by heating through physical or chemical action. Further, magnetic-optical recording media also can be used, where a magnetic substance is used as a recording material and a mark is formed by applying heat and magnetic field at the same time. Among these recording media, the phase-change recording media and the recordable dye media, which can realize the formation of a mark by an irradiation of light only, are preferable, because a high-resolution mark can be formed. In particular, the phase-change recording media are more preferable, because a mark can be formed so that a width of the re-crystallization region and a variation in the position of the mark can be controlled appropriately.

The present invention can provide an information recording device and an information recording method, where pulse light with a pulse width less than 1 ns is utilized for forming a mark in an optical recording medium. Thereby, generation of re-crystallization regions and a variation in the position of marks can be controlled appropriately and information can be recorded on an optical recording medium at high density.

The present invention further can provide a compact and lightweight optical recording medium, in which a space between the marks can be narrowed and a large amount of mass information such as a color still picture can be recorded.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An optical information recording device that records information on an optical recording medium, the device comprising:
a laser beam generation device for generating a pulse light with a pulse width less than 1 ns; and
a mark formation device for collecting the pulse light and irradiating a recording layer in the optical recording medium with the pulse light so as to form a mark in the recording layer.

2. The optical information recording device according to claim 1, wherein the pulse width of the pulse light generated by the laser beam generation device is 10 ps or less.

3. The optical information recording device according to claim 1, wherein an energy of the pulse light is approximately 2 nJ/μm².

4. The optical information recording device according to any one of claims 1 to 3, wherein the pulse light is generated by a solid-state laser.

5. The optical information recording device according to any one of claims 1 to 3, wherein the optical recording medium is a phase-change recording medium.

6. The optical information recording device according to claim 5, wherein the recording layer is made of TeGeSb.

7. The optical information recording device according to claim 5, wherein the pulse light is generated by a solid-state laser.

8. The optical information recording device according to any one of claims 1 to 3, further comprising:
a second laser beam generation device for generating a laser beam whose laser output is set at a level so as to erase the mark formed on the optical recording medium and irradiating the optical recording medium with the laser beam prior to the pulse light generated by the laser beam generation device.

9. An information recording method of recording information on an optical recording medium, the method comprising:
generating a pulse light with a pulse width less than 1 ns;
collecting the pulse light; and
irradiating a recording layer in the optical recording medium with the pulse light so as to form a mark in the recording layer.

10. The information recording method according to claim 9, wherein the pulse width of the pulse light is 10 ps or less.

11. The information recording method according to claim 9 or 10, wherein an energy of the pulse light is approximately 2 nJ/μm².

12. The information recording method according to claim 9 or 10, wherein the pulse light is generated by a solid-state laser.

13. The information recording method according to claim 9 or 10, wherein the optical recording medium is a phase-change recording medium.

14. The information recording method according to claim 13, wherein the recording layer is made of TeGeSb.

15. The information recording method according to claim 13, wherein the pulse light is generated by a solid-state laser.

16. The information recording method according to claim 9 or 10, further comprising:
generating a laser beam whose laser output is set at a level so as to erase the mark formed on the optical recording medium and irradiating the optical recording medium with the laser beam prior to the pulse light generated in the pulse light generation step.

17. An optical recording medium, comprising:
a recording layer in which a mark is formed by an irradiation of a pulse light with a pulse width less than 1 ns.

18. The optical recording medium according to claim 17, wherein the pulse width of the pulse light is 10 ps or less.

19. The optical recording medium according to claim 17 or 18, wherein the optical recording medium is a phase-change recording medium.

20. The optical recording medium according to claim 19, wherein the recording layer is made of TeGeSb.

21. The optical recording medium according to claim 17 or 18, wherein substantially no re-crystallization region is formed on the periphery of the mark.
